(19) United States
(12) Patent Application Publication
(10) Pub. No.: US 2006/0222478 A1
(43) Pub. Date: Oct. 5, 2006

(54) Processing apparatus, and system and program for monitoring and controlling fan filter unit

(75) Inventor: Shinji Wakabayashi, Nirasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 11/362,774

(22) Filed: Feb. 28, 2006

Related U.S. Application Data
(60) Provisional application No. 60/666,706, filed on Mar. 31, 2005.

(30) Foreign Application Priority Data
Mar. 31, 2005 (JP) 2005-102684

(51) Int. Cl. B65H 1/00; B65G 47/90

(52) U.S. Cl. 414/225.01; 414/816

(57) ABSTRACT

A processing apparatus, and a system and program for monitoring and controlling a fan filter unit are provided. The processing apparatus includes a mounting unit for mounting a transport container for accommodating therein a plurality of substrates, a processing unit for performing a process on a substrate, a transfer unit having a transfer mechanism for transferring the substrate between the transport container mounted on the mounting unit and the processing unit, a clean air supply unit for supplying a clean air into the transfer unit, a wind velocity measuring unit, and a control unit. The transfer mechanism is provided with a wind velocity measuring unit for measuring a wind velocity of the clean air in the transfer unit.

### FIELD OF THE INVENTION

The present invention relates to a processing apparatus, and a system and program for monitoring and controlling a fan filter unit; and, more particularly, to a scheme for measuring a wind velocity of fan filter units in a transfer unit of the processing apparatus.

### BACKGROUND OF THE INVENTION

In a manufacturing of a semiconductor device, processing apparatuses are used in performing various processes such as an etching process on a target substrate, e.g., a semiconductor wafer. A processing apparatus includes a mounting unit for mounting thereon a FOUP (Front Opening Unified Pod) serving as a transport container for accommodating therein a plurality of, e.g., twenty-five, wafers; a processing unit for performing a predetermined process on the wafer; and a transfer unit having a transfer mechanism for transferring the wafer between the FOUP disposed on the mounting unit and the processing unit. On a ceiling portion of the transfer unit, fan filter units are provided as a clean air supply unit for supplying a clean air into the transfer unit. The fan filter unit includes a fan and a filter.

In the transfer unit, it is required to maintain a highly clean environment in which no particles (including dust) are present by providing all the time a down flow of clean air and increasing an internal pressure in order to prevent a contamination of the wafer by the particles. Meanwhile, if a turbulent flow is generated in the transfer unit by a performance deterioration of the fan filter units due to a blocking of the filters or the like, or a performance irregularity between the adjacent fan filter units, the particles are likely to lift up not to be removed from the transfer unit.

On this account, in the processing apparatus, it is required to measure wind velocities at a plurality of locations in the transfer unit so as to check whether the fan filter units are properly functioning, to thereby maintain a high cleanliness in the transfer unit. Conventionally, the wind velocities in the transfer unit are measured in such a manner that a measuring probe attached to a tip of a rod is inserted from the outside into the transfer unit by an operator, or the operator himself enters the inside of the transfer unit to carry out the measurement.

Further, as related schemes, Japanese Patent Laid-open Application No. H11-74169 discloses an apparatus including an anemometer on top of the fan filter units (a substrate processing apparatus including a life determination device of an atmosphere processing unit); and Japanese Patent Laid-open Application No. H9-320914 discloses an apparatus (a processing system) which detects air flows between the respective units based on wind directions therebetween by installing wind direction detecting units between the respective transfer and processing units thereof. However, neither of these measures the wind velocity in the transfer unit by using a transfer mechanism.

In the above-described processing apparatus, the wind velocity has to be measured by the operator, and thus, a measurement operation requires much labor and time. Further, it is difficult to accurately position the measuring probe at a predetermined measuring position, so that a measurement error is likely to be increased. Moreover, in case the operator enters the inside of the transfer unit, a workability is poor due to a limited space of the transfer unit. Further, the transfer mechanism needs to be stopped during the measurement operation for safety.

### SUMMARY OF THE INVENTION

It is, therefore, an object of the present invention to provide a processing apparatus, and a fan filter unit monitoring and controlling system and program, wherein a measurement operation of a wind velocity in a transfer unit can be performed mechanically by a transfer mechanism in a prompt and accurate manner to thereby reduce labor and improve reliability.

In accordance with a first aspect of the present invention, there is provided a processing apparatus including: a mounting unit (FOUP platform) for mounting a transport container for accommodating therein a plurality of substrates; a processing unit for performing a process on a substrate; a transfer unit having a transfer mechanism for transferring the substrate between the transport container mounted on the mounting unit and the processing unit; and a clean air supply unit for supplying a clean air into the transfer unit, wherein the transfer mechanism is provided with a wind velocity measuring unit for measuring a wind velocity of the clean air in the transfer unit.

In accordance with first aspect of the present invention, a measurement operation of the wind velocity in the transfer unit can be performed mechanically by the transfer mechanism to thereby reduce labor and improve reliability in a prompt and accurate manner.

In accordance with a second aspect of the present invention, there is provided a processing apparatus including: a mounting unit for mounting a transport container for accommodating therein a plurality of substrates; a processing unit for performing a process on a substrate; a transfer unit having a transfer mechanism for transferring the substrate between the transport container mounted on the mounting unit and the processing unit; a fan filter unit having a fan and a filter for supplying a clean air into the transfer unit; a wind velocity measuring unit provided at the transfer mechanism to measure a wind velocity of the clean air in the transfer unit; and a control unit for moving the wind velocity measuring unit to a predetermined measuring point in the transfer unit by the transfer mechanism to collect measurement data and controlling operations of the fan filter unit based on the measurement data.

In accordance with the second aspect of the present invention, a measurement operation of the wind velocity in the transfer unit can be performed mechanically by the transfer mechanism to thereby reduce labor and improve reliability.

In accordance with a third aspect of the present invention, there is provided a fan filter unit monitoring and controlling system for monitoring and controlling fan filter units, disposed in a plurality of divided zones of a ceiling portion of a transfer unit for supplying a clean air into the transfer unit having a transfer mechanism for transferring a substrate, the system including: a fan filter unit controller for controlling operations of the fan filter units; a transfer mechanism controller for controlling the transfer mechanism; a wind velocity measuring unit provided at the transfer mechanism to measure a wind velocity of the clean air in the transfer unit; a user interface for inputting a measuring point at each zone of the transfer unit; and a controller, connected to the user interface, the transfer mechanism controller and the wind velocity measuring unit by a network, for collecting measurement data of the respective measuring points from the transfer mechanism controller and the wind velocity measuring unit to thereby control and monitor operation states of the fan filter units.

In accordance with a third aspect of the present invention, a measurement operation of the wind velocity in the transfer unit can be performed mechanically by the transfer mechanism to thereby reduce labor and improve reliability. Further, a high cleanliness is maintained in the transfer unit.

In accordance with a fourth aspect of the present invention, there is provided a program for performing, on a computer, a monitoring and controlling of fan filter units, disposed in a plurality of divided zones of a ceiling portion of a transfer unit, for supplying a clean air into the transfer unit having a transfer mechanism for transferring a substrate, the program including: a measurement data collection module for moving a wind velocity measuring unit provided at the transfer mechanism provided in the transfer mechanism to a predetermined measuring point in the transfer unit by the transfer mechanism to collect measurement data; and a fan filter unit monitoring and controlling module for monitoring operation states of the fan filter units and controlling operations of the fan filter units based on the measurement data.

In accordance with the fourth aspect of the present invention, a measurement operation of the wind velocity in the transfer unit can be performed mechanically by the transfer mechanism to thereby reduce labor and improve reliability. Further, a high cleanliness is maintained in the transfer unit.

### BRIEF DESCRIPTION OF THE DRAWINGS

The above and other objects and features of the present invention will become apparent from the following description of preferred embodiment given in conjunction with the accompanying drawings, in which:

FIG. 1 offers a perspective view schematically showing a processing apparatus in accordance with a preferred embodiment of the present invention;

FIG. 2 shows a side cross sectional view schematically showing the same processing apparatus;

FIG. 3 is a plane view schematically showing a configuration of the entire processing apparatus;

FIG. 4 depicts a view showing an example of a wind velocity measuring unit;

FIG. 5 presents a cross sectional view schematically showing an example of a fan filter unit;

FIG. 6 offers a cross sectional view schematically showing another example of the fan filter unit;

FIG. 7 shows a view schematically showing a configuration of a system controller in the processing apparatus shown in FIG. 3;

FIG. 8 is a plane view schematically showing modification of the processing apparatus in accordance with the preferred embodiment of the present invention;

FIGS. 9A and 9B depict views schematically showing another modification of the processing apparatus in accordance with the preferred embodiment of the present invention, wherein FIG. 9A is a plane view, FIG. 9B is a cross sectional view taken along a line A-A of FIG. 9A; and

FIG. 10 presents a longitudinal cross sectional view schematically showing still another modification of the processing apparatus in accordance with the preferred embodiment of the present invention.

### DETAILED DESCRIPTION OF THE PREFERRED EMBODIMENTS

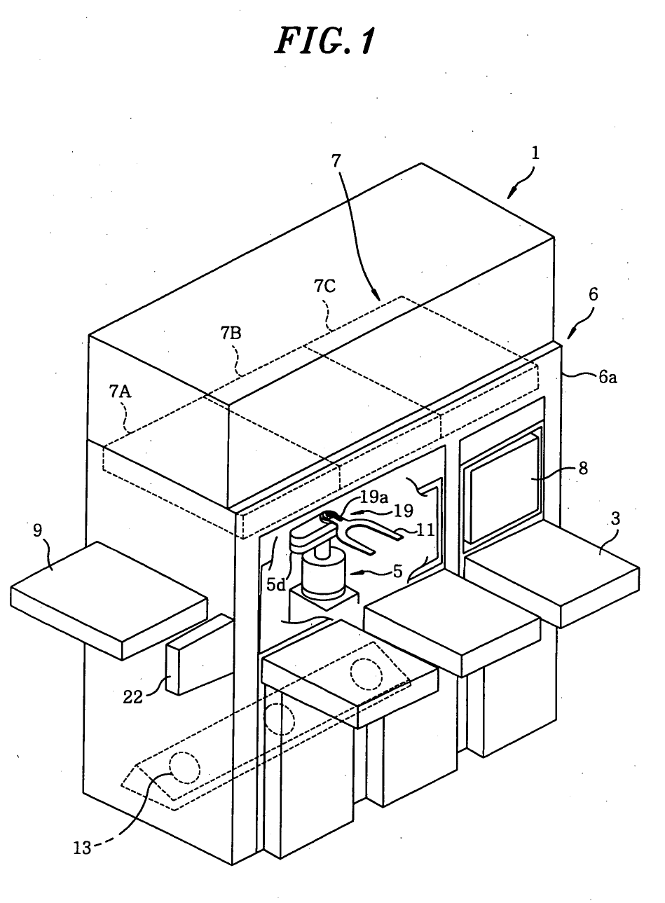

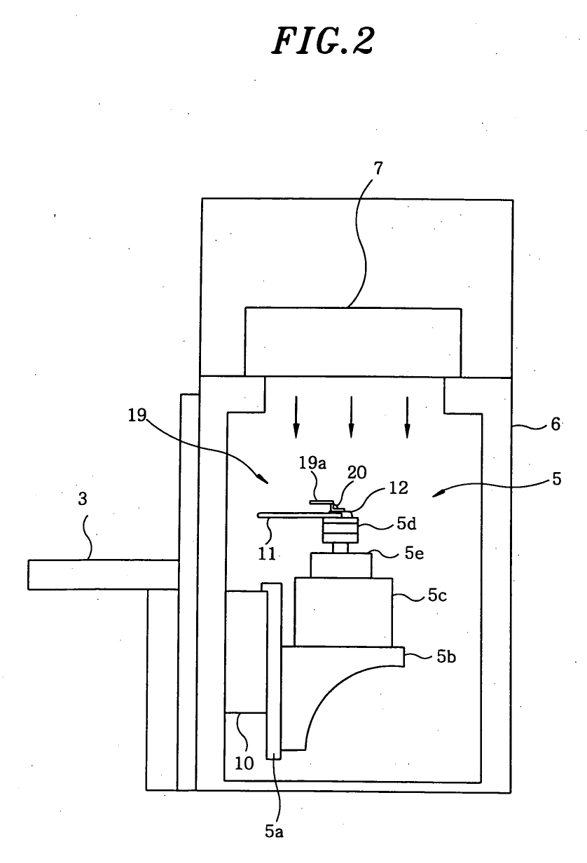

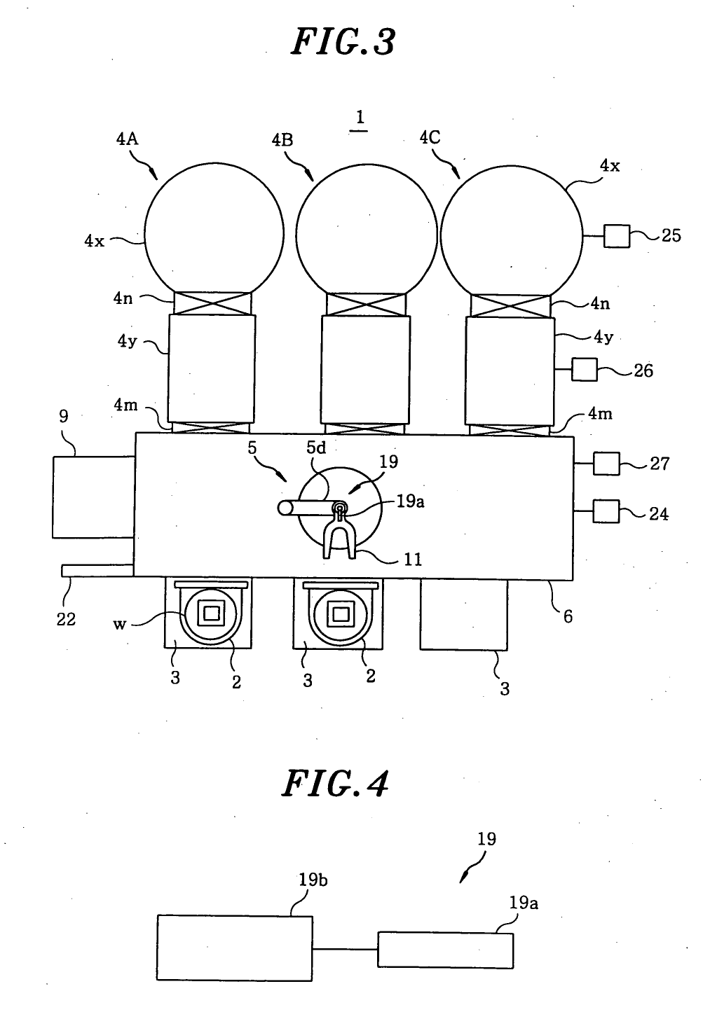

Hereinafter, a preferred embodiment of the present invention will be described with reference to the accompanying drawings. FIG. 1 is a perspective view schematically showing a processing apparatus in accordance with a preferred embodiment of the present invention. FIG. 2 is a side cross sectional view schematically showing the same processing apparatus; and FIG. 3 is a plane view schematically showing a configuration of the entire processing apparatus.

Referring to these FIGS. 1 to 3, a processing apparatus (processing system) 1 is a single-wafer processing apparatus transferring a semiconductor wafer W serving as a target substrate and performing a predetermined process on the wafer W on a single wafer basis. The processing apparatus 1 is installed in a clean room under a clean atmosphere. The processing apparatus 1 includes: a plurality of, e.g., three, FOUP platforms 3, each serving as a mounting unit for mounting thereon a FOUP 2 serving as a transport container accommodating a plurality of, e.g., 25, wafers w; three process ships 4A to 4C, each serving as a processing unit for performing a predetermined process, e.g., an etching process, on the wafer w; a loader unit 6 serving as a transfer unit having a transfer mechanism 5 for transferring the wafer w between the FOUPs 2 on the FOUP platforms 3 and the process ships 4A to 4C; and fan filter units (FFU's) 7 serving as a clean air supply unit for supplying a clean air into the loader unit 6.

Each of the process ships 4A to 4C includes: a processing unit (for example, a vacuum processing unit) 4x for performing a predetermined process on the wafer W; and a load-lock chamber 4y having a built-in transfer arm (not shown) for transferring the wafer w to the corresponding processing unit 4x and one or two vertically movable buffer mechanisms each for temporarily mounting a wafer. The processing unit 4x includes a cylindrical processing container (chamber) and an upper electrode and a lower electrode disposed in the chamber, wherein the distance between the upper and the lower electrode is set to be proper to perform the etching process, for example, a reactive ion etching process on the wafer. Further, the lower electrode has at the top thereof an electrostatic chuck for holding thereon the wafer by a Coulomb force or the like.

In the processing unit 4x, a processing gas introduced into the chamber is converted into a plasma by an electric field generated by the electrodes, to produce ions and radicals, so that the reactive ion etching process is performed on the wafer w by the ions and the radicals. Further, in the processing unit 4x, an isotropic etching process is performed on the wafer w by a COR (Chemical Oxide Removal) process by introducing a corrosion gas (e.g., NH₃) and HF into the chamber without using the electric field.

In the process ships 4A to 4C, an internal pressure of each processing unit 4x is maintained at a vacuum, an internal pressure of each load-lock chamber 4y can be varied between a vacuum pressure and an atmospheric pressure when required, and an internal pressure of the loader unit 6 is maintained at the atmospheric pressure. On this account, the each load-lock chamber 4y serves as a vacuum transfer antechamber whose internal pressure is controllable by providing gate valves 4m and 4n at connection portions with the loader unit 6 and the processing unit 4x, respectively.

The loader unit 6 includes a box shaped housing 6a which is elongated in a lateral direction; a transfer mechanism 5 provided in the housing 6a; the FOUP platforms 3 serving as load ports provided on one sidewall (front portion) of the housing 6a; and a plurality of, e.g., three, loading/unloading doors (openers) 8 serving as input ports of the wafers, disposed on the sidewall correspondingly to the respective FOUP platforms 3. The inside of the loader unit 6 is set to a mini-environment in which a cleanliness is maintained. The three process ships 4A to 4C are connected to the opposite sidewall (rear portion) of the loader unit 6. An orienter 9 serving as a wafer position alignment mechanism, for aligning an orientation (i.e., an orientation flat or a position of a notch) of the wafer w loaded from the FOUP 2 into the loader unit 6, is connected on one end in a longitudinal direction of the loader unit 6.

As shown in FIG. 2, the transfer mechanism 5 includes an x-axis moving unit 5a which is capable of moving back and forth along a guide rail 10 disposed in the loader unit 6 in a length direction by an operation of an electromagnet; a vertically movable z-axis moving unit 5b provided on the x-axis moving unit 5a; a horizontally rotatable turn table 5e provided to the z-axis moving unit 5b via a O-axis driving unit 5c and having a built-in R-axis driving motor; and a multi-joint transfer arm 5d provided on the turn table, the multi-joint transfer arm 5d being extensible and contractible in a radial direction (R-axis), that is, in the horizontal direction. The transfer arm 5d includes at a leading end a pick (supporting portion) 11 for supporting the wafer w. The pick 11 is formed of a U-shaped thin plate made of, e.g., ceramic. A pick holder 12 for attachably and detachably attaching the pick 11 is provided at the leading end of the transfer arm 5d.

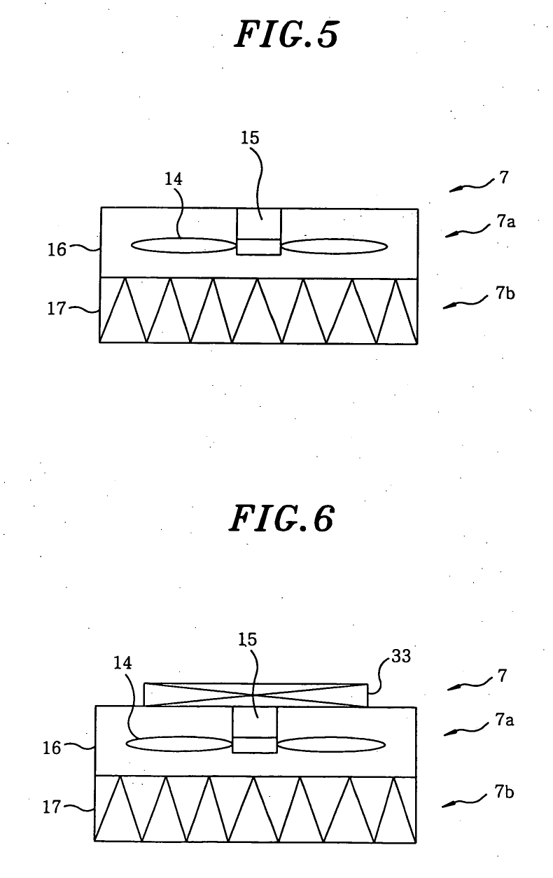

The FFU's 7 are provided at an upper portion, i.e., a ceiling portion, of the loader unit 6 to let in a clean air of an inside of clean room, and then, generate a laminar down flow of a highly clean air. Further, an exhaust fan unit 13 for exhausting the clean air to the outside is disposed at a bottom portion of the loader unit 6. As shown in FIG. 5, each FFU 7 includes a fan (air blower) 7a and a filter 7b, wherein the fan 7a is disposed above the filter 7b. The fan 7a produces a pressurized air to flow through the filter 7b, and, therefore highly clean air flows into the loader unit 6 through the each filter 7b. The internal pressure of the loader unit 6 is set to be higher than an external pressure (the atmospheric pressure) so that particles cannot enter the loader unit 6 from the outside thereof.

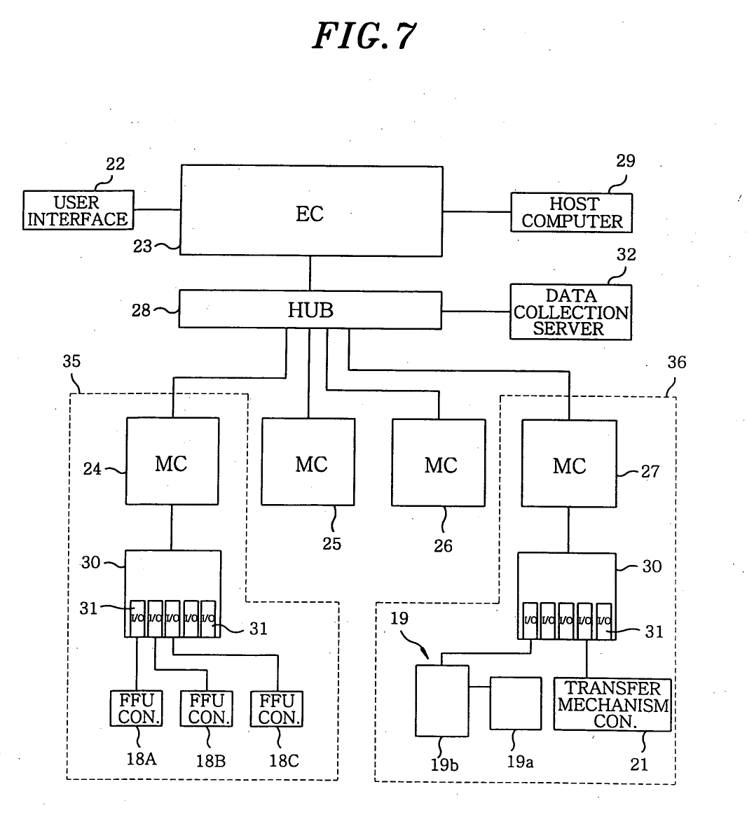

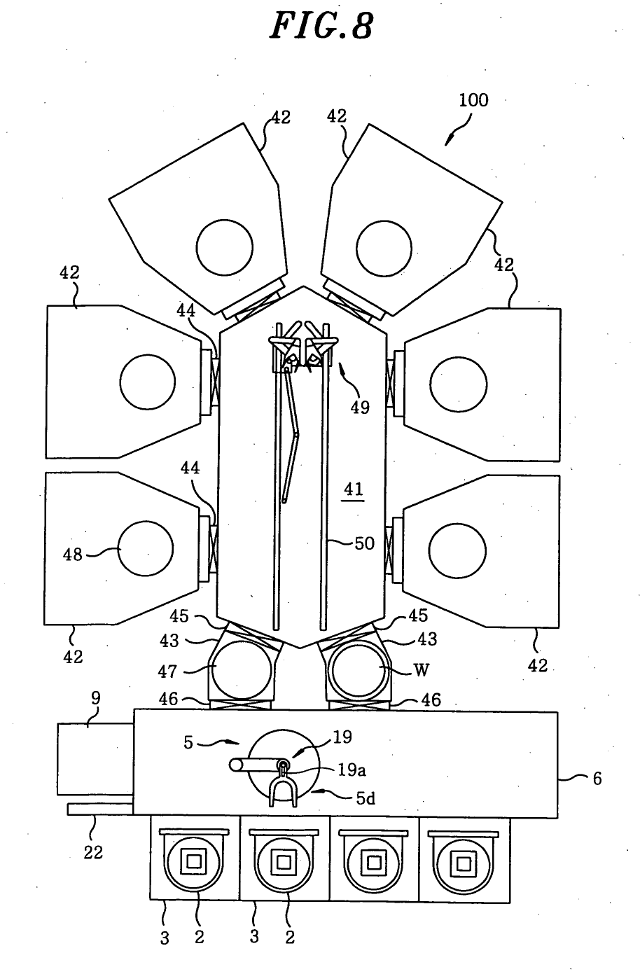

The fan 7a includes blades 14 and an electric motor 15 accommodated in a quadrilateral frame 16. The filter 7b is accommodated in a quadrilateral frame 17 and is formed of, for example, an ULPA (Ultra Low Penetration Air) filter. The ceiling portion of the loader unit 6 is divided into a plurality of zones in which a plurality of FFU's, e.g., three, FFU's 7A to 7C, is disposed, respectively. Fan filter unit controllers (hereinafter referred to as “FFU controllers”) 18A to 18C are provided (see FIG. 7) to the respective FFU's 7A to 7C for controlling the operation thereof (for example, a rotation of the fan).

The transfer mechanism 5 is provided with a wind velocity measuring unit 19 for measuring a velocity of the clean air in the loader unit 6. The wind velocity measuring unit 19 is constituted by an anemometer. As shown in, for example, FIG. 4, the wind velocity measuring unit 19 may include a measuring probe 19a serving as a wind velocity sensor for electrically detecting the wind velocity by using, e.g., a property that an electrical resistance of a heating wire is varied depending on the wind velocity; and an anemometer main body 19b which operates and outputs wind velocity measurement data based on a detection signal inputted from the corresponding measuring probe 19a. The anemometer serving as the wind velocity measuring unit 19 or the measuring probe 19a is provided on the transfer arm 5d of the transfer mechanism 5. The anemometer main body 19b may be disposed, for example, at the x-axis moving unit 5a of the transfer mechanism 5, or at the outside of the loader unit 6.

A vane anemometer and an ultrasonic anemometer as well as the above-described thermal wind velocity sensor may be used as the wind velocity measuring unit in accordance with the preferred embodiment. The flow velocity can be determined by the vane anemometer counting the number of revolutions of a vane wheel that rotates at a velocity proportional to that of a fluid, with a switch adjacent thereto. Further, a wind direction and the wind velocity can be determined by using the ultrasonic anemometer, which generally performs ultrasonic pulse velocity measurement by generating suitable ultrasonic pulses and accurately measuring the time of their transmission (transit time) through the material tested. Further, an anemometer of an ultrasonic vortex type (for example, a vortex type VA sensor manufactured by Hontzsch), which generates vortices of a fluid by a Karman vortex phenomenon to measure a frequency of vortex formation by an ultrasonic sensor, has a good stability and a reliability over a long period of time even under a corrosive gas environment including Cl or Br based gas. This is because the sensor is not exposed to the fluid that frequently produces mechanical and electrical damage and wear on the sensor.

As shown in FIG. 2, the anemometer or the measuring probe 19a is attached at the leading end of the transfer arm 5d, for example, at the pick holder 12 by an adhesion member (attachment) 20. Therefore, it is possible to promptly and accurately move the measuring probe 19a to a plurality of predetermined measuring points set in the loader unit 6 by the transfer arm 5d of the transfer mechanism 5 to measure the wind velocity thereof.

The processing apparatus (processing system) 1 includes a FFU monitoring and controlling system for monitoring and controlling FFU's (7A to 7C) which are disposed in a plurality of divided zones of the ceiling portion to supply the clean air in the loader unit 6 having a transfer mechanism 5 for transferring a wafer w. Further, the FFU monitoring and controlling system includes MC's (Module Controllers) 24 to 27 (to be described later) serving as control units for moving the wind velocity measuring unit 19 to the predetermined measuring point in the loader unit 6 by the transfer mechanism 5 to collect measurement data and controlling operations of the fan filter units 7 (7A to 7C) based on the measurement data; and a EC (Equipment Controller) 23 serving as a general controller for generally monitoring the respective MC's.

The FFU monitoring and controlling system includes a FFU control unit 35 and a transfer control unit 36. The FFU control unit 35 includes FFU controllers 18A to 18C for controlling fan rotations of the FFU's 7A to 7C; an I/O module 30; and the FFU module controller MC 24 for controlling operations of the respective FFU controllers 18A to 18C through the I/O module 30. The transfer control unit 36 includes a transfer mechanism controller 21; the wind velocity measuring unit 19; an I/O module 30; the transfer module controller MC 27 for performing control of a transfer sequence through the I/O module 30. Further, the FFU monitoring and controlling system includes: a user interface 22 for inputting measuring points at each of zones in the loader unit 6; and the EC 23, serving as a general controller, connected to the MC's 24 to 27 through a switching hub 28 for collecting the measurement data of the respective measuring points to monitor and generally control operation states of the respective FFU's 7A to 7C.

Further, the MC 24 and the MC 27 may be integrated as a single controller serving as a loader module control unit. In this case, the FFU monitoring and controlling system may include the FFU controllers 18A to 18C for controlling the operations of the respective FFU's 7A to 7C; the transfer mechanism controller 21 for controlling the transfer mechanism 5; the wind velocity measuring unit 19 provided to the transfer mechanism 5 for measuring the wind velocity of the clean air in the loader unit 6; the user interface 22 for inputting the measuring point at each of zones in the loader unit 6; and the EC 23, serving as a general controller, connected via network to the user interface 22, the transfer mechanism controller 21, and the wind velocity measuring unit 19 for collecting the measurement data of the respective measuring points from the transfer mechanism controller 21 and the wind velocity measuring unit 19 to monitor and generally control the operation states of the respective FFU's 7A to 7C.

The processing apparatus or the processing system includes three process ships 4A to 4C; a system controller for controlling the operation of the loader unit 6; the user interface 22 disposed at one end of the length direction of the loader unit 6. The user interface 22 includes an input unit (keyboard) and a display unit (monitor) formed of, e.g., a LCD (Liquid Crystal Display), wherein the display unit displays operation states of the respective constituent elements of the processing apparatus 1.

FIG. 7 is a schematic view showing a configuration of the system controller of the processing apparatus or the processing system shown in FIGS. 1 to 3. As shown in FIG. 7, the system controller includes the EC 23; a plurality of, e.g., four, MC's (Module Controllers) 24 to 27; and the switching hub 28 for connecting the EC 23 and the MC's 24 to 27. The EC's of the system controller is connected through a LAN (Local Area Network) to a host computer 29 serving as a MES (Manufacturing Execution System) for managing manufacturing processes carried out in the whole factory in which the processing apparatus 1 is installed. The host computer 29 in communication with the system controller feedbacks to a main operation system (not shown) real time information about the processes carried out in the factory, and performs the judgments about the processes by considering a total load of the factory.

The EC 23 controlling the respective MC's 24 to 27 is the general control unit for controlling operations of the entire processing apparatus. Further, the EC 23 includes a CPU, a RAM, a HDD or the like, and controls operations of the loader unit 6 and the respective process ships 4A to 4C in such a manner that according to a processing method of the wafer, i.e., a program (including position information of the measuring points) corresponding to a recipe, specified through the user interface 22 by a user or the like, the CPU transmits a control program corresponding to the recipe to the respective MC's 24 to 27.

The switching hub 28 selectively connects the EC 23 to the respective MC's 24 to 27 according to a control signal from the EC 23. The MC's 24 to 27 are general control units for controlling the operations of the respective process ships 4A to 4C and the loader unit 6. Each of the MC's 24 to 27 is connected to the corresponding I/O module 30 through a GHOST network. The GHOST network is implemented by an LSI called a GHOST (General High-Speed Optimum Scalable Transceiver). In the GHOST network, the MC's 24 to 27 are masters, and the I/O modules 30 are slaves.

Each I/O module 30 includes a plurality of I/O units 31 connected to each of constituent elements (end devices) of the loader unit 6, and transmits control signals to the end devices and output signals from the end devices. An I/O board for controlling an input/output of digital, analog, and serial signals in the I/O units 31 is also connected to the GHOST network.

In the system controller shown in FIG. 7, a plurality of the end devices are not directly connected to the EC 23. Instead, the I/O units 31 connected to a plurality of the end devices are modularized to constitute the I/O module 30, and the each I/O module 30 is connected to the EC 23 through the MC's 24 to 27 and the switching hub 28 and, thus, a communication system can be simplified.

Further, because the GHOST of the MC's 24 to 27 refers to an address of the I/O unit 31 in the control signals transmitted by the CPU of the MC's 24 to 27 by referring to the address of the I/O unit connected to a desired end device and an address of the I/O module including the I/O unit, the switching hub 28, the transfer mechanism controller 21, the wind velocity measuring unit 19, and the FFU controllers 18A to 18C need not to send a request to the CPU about a send location of the control signals. Therefore, the control signals can be transmitted effectively.

Further, the system controller may include a data collection server 32 serving as a data collection storage unit for accumulating and storing data outputted from the wind velocity measuring unit 19. In this case, detection signals which are data outputted from the measuring probe 19a are outputted as the analog signals from the anemometer main body 19b, and inputted to the I/O unit 31, and then, inputted to the data collection server 32 through the network.

The processing apparatus 1 thus constituted includes the FOUP platforms 3 for mounting thereon a FOUP's 2 accommodating a plurality of wafers w; process ships 4A to 4C for performing a predetermined process on the wafers w; a loader unit 6 having a transfer mechanism 5 for transferring the wafers w between the FOUP's 2 on the FOUP platforms 3 and the process ships 4A to 4C; and FFU's 7 serving as a clean air supply unit for supplying the clean air into the loader unit 6, wherein the transfer mechanism 5 is provided with the wind velocity measuring unit 19 for measuring the wind velocity of the clean air in the loader unit 6. Therefore, a measurement operation of the wind velocity in the loader unit 6 can be performed mechanically by the transfer mechanism 5 in a prompt and accurate manner to thereby reduce labor required for the measurement operation of the wind velocity, and improve reliability.

Further, the processing apparatus or the processing system 1 includes the MC's 24 to 27 serving as the control unit for moving the wind velocity measuring unit 19 to the predetermined measuring points in the loader unit 6 by the transfer arm 5d of the transfer mechanism 5 to collect measurement data and controlling the operations of the FFU's 7 based on the measurement data. Therefore, a measurement operation of the wind velocity in the loader unit 6 can be performed mechanically by the transfer arm 5d of the transfer mechanism 5 in a prompt and accurate manner. Further, the high cleanliness is maintained in the loader unit 6 by maintaining the FFU's 7 in an optimum state. Accordingly, labor required for the measurement operation of the wind velocity can be reduced, and the reliability of the processing apparatus or the processing system can be improved.

Further, the FFU monitoring and controlling system serves to monitor and control the FFU's 7A to 7C disposed in a plurality of divided zones of a ceiling portion of a loader unit, for supplying a clean air into the loader unit 6 having a transfer mechanism 5 for transferring a wafer w; and includes the FFU controllers 18A to 18C for controlling operations of the FFU's 7A to 7C; a transfer mechanism controller 21 for controlling the transfer mechanism 5; a wind velocity measuring unit 19 provided at the transfer mechanism 5 to measure a wind velocity of the clean air in the loader unit 6; a user interface 22 for inputting a measuring point at each zone of the loader unit 6; and a EC 23 serving as a general controller for generally performing a monitoring and controlling through module controllers 24 to 27, connected to the user interface 22, the transfer mechanism controller 21 and the wind velocity measuring unit 19 by a network, for collecting measurement data of the respective measuring points from the transfer mechanism controller 21 and the wind velocity measuring unit 19 to thereby control and monitor operation states of the FFU's 7A to 7C. Therefore, a measurement operation of the wind velocity in the loader unit 6 can be performed mechanically by the transfer mechanism 5 in a prompt and accurate manner. Further, an in-surface wind velocity uniformity in the loader unit 6 can be maintained by maintaining the respective FFU's in an optimum state and adjusting the wind velocity between the zones, and thus, a high cleanliness can be maintained in the loader unit 6. Further, labor required for the measurement operation of the wind velocity can be reduced, and the reliability of the processing apparatus or the processing system can be improved.

The object of the present invention is also achieved in such a manner that a program of a software, or a recording medium (storage medium) storing the program for implementing the functions of the above-described preferred embodiment is supplied to the EC 23, and then, the CPU of the EC 23 reads and perform the program stored in the recording medium. In this case, the program implements the functions of the above-described preferred embodiment, and thus, the program and the recording medium storing the program constitute the present invention.

The program performs, on a computer, a monitoring and controlling of FFU's 7A to 7C, disposed in a plurality of divided zones, of a ceiling portion, for supplying a clean air in a loader unit 6 having a transfer mechanism 5 for transferring a wafer w; and includes a measurement data collection module (step of a measurement data collection) for moving a wind velocity measuring unit 19 provided at the transfer mechanism 5 to a predetermined measuring point in the loader unit 6 by the transfer mechanism 5 to collect measurement data; and a FFU monitoring and controlling module (step of a FFU monitoring and controlling) for monitoring operation states of the FFU's 7A to 7C and controlling operations of the FFU's 7A to 7C based on the measurement data. In accordance with the program, a measurement operation of the wind velocity in the loader unit 6 can be performed mechanically by the transfer mechanism 5 in a prompt and accurate manner. Further, a high cleanliness is maintained in the loader unit by maintaining the FFU's in an optimum state. Accordingly, labor required for the measurement operation of the wind velocity can be reduced, and the reliability of the processing apparatus or the processing system can be improved.

Further, as the recording medium for supplying the program, a floppy (registered trademark) disk, a hard disk, a magneto-optical disk, a CD-ROM, a CD-R, a CD-RW, a DVD-ROM, a DVD-RAM, a DVD-RW, a magnetic tape, or the like may be used. Further, the program may be supplied by downloading from the network.

FIG. 6 is a cross sectional view schematically showing another example of the FFU. In FIG. 6, the constituent elements similar to those of the FFU of FIG. 5 are designated by the like reference numerals and description thereof is omitted. As shown in FIG. 6, the FFU may include an opening degree control unit 33 installed at an air inlet opening for controlling an opening degree of an air inlet opening, and it may be constituted so as to control the opening degree control unit 33.

FIG. 8 is a plane view schematically showing a configuration of a modified embodiment of the processing apparatus in accordance with the preferred embodiment of the present invention. In FIG. 8, like parts similar to those of the processing apparatus of FIGS. 1 to 3 are designated by the like reference numerals and description thereof is omitted. In FIG. 8, the processing apparatus 100 includes a transfer unit 41 of a hexagonal shape which is elongated in the longitudinal direction; six processing chambers 42 radially disposed around the transfer unit 41; a loader unit 6; and two load-lock chambers 43 disposed between the loader unit 6 and the transfer unit 41 to connect the loader unit 6 and the transfer unit 41. The transfer unit 41 and the respective processing chambers 42 are maintained at a vacuum pressure, and the transfer unit 41 and the respective processing chambers 42 are connected through respective gate valves.

In the processing apparatus 100, the loader unit 6 is maintained at the atmospheric pressure. On the other hand, the internal pressure of the transfer unit 41 is maintained at a vacuum pressure. For this reason, the each load-lock chamber 43 is constituted as a vacuum antechamber whose internal pressure is controllable by installing gate valves 45 and 46 at joint portions of the transfer unit 41 and the loader unit 6, respectively. Further, each load-lock chamber 43 includes a wafer mounting table 47 for temporarily mounting the wafer w transferred between the loader unit 6 and the transfer unit 41.

Each processing chamber 42 includes a wafer mounting table 48 for mounting thereon a wafer on which process is performed. The transfer unit 41 includes a transfer arm unit 49 having two transfer arms of a scalar arm type. The transfer arm unit 49 moves along a guide rail 50 disposed in the transfer unit 41 along a length direction thereof, to transfer the wafer w between each processing chamber 42 and the load-lock chamber 43. This processing apparatus 100 can also obtain the same effects as those of the processing apparatus 1 shown in FIGS. 1 to 3.

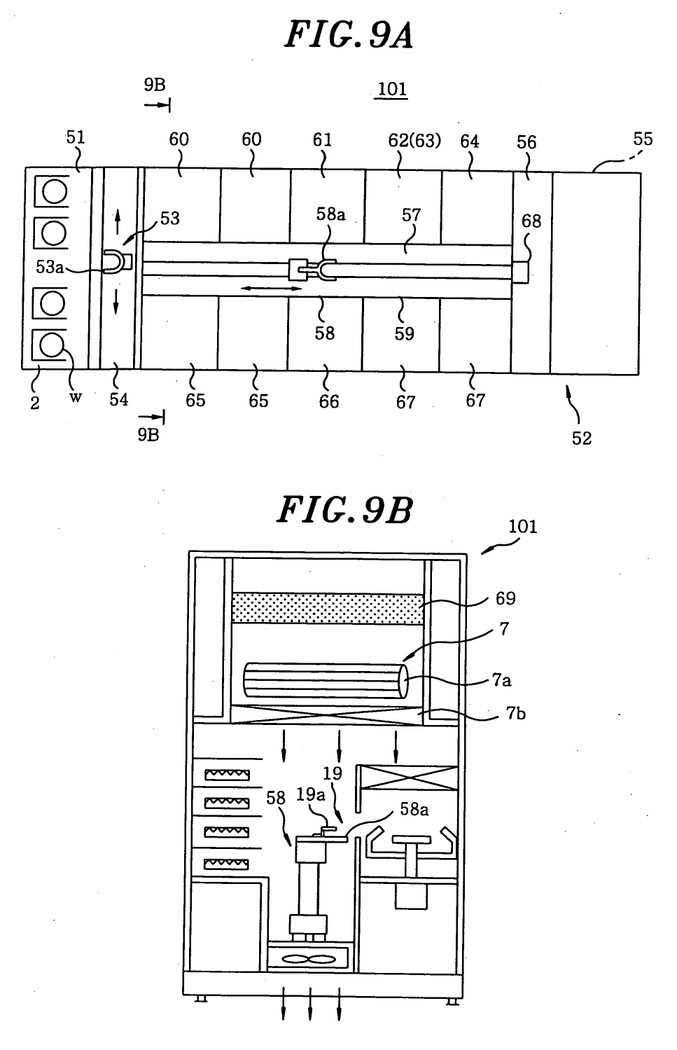

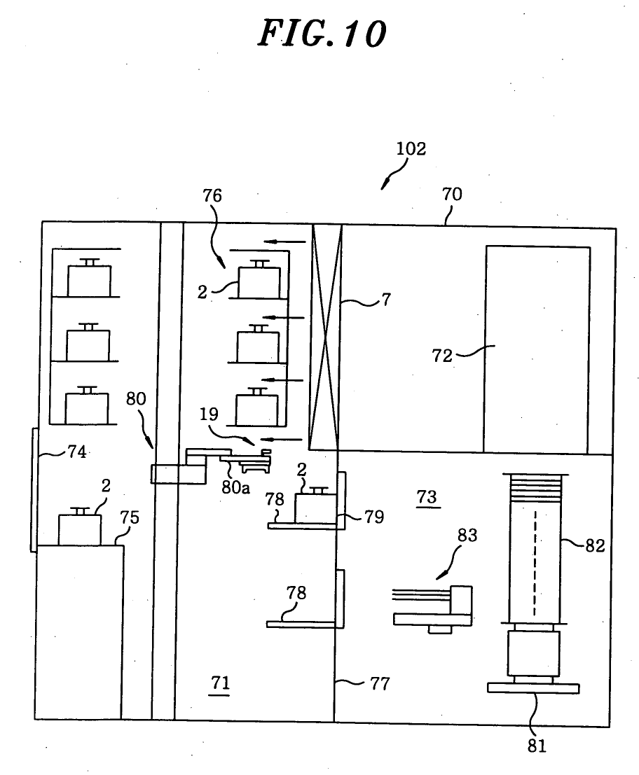

FIG. 9 is a view schematically showing a configuration of still another modified embodiment of the processing apparatus in accordance with the preferred embodiment of the present invention, wherein FIG. 9A is a plane view, FIG. 9B is a cross sectional view taken along the line 9B-9B of FIG. 9A. A processing apparatus (processing system) 101 shown in FIGS. 9A and 9B is constituted as a coating/developing system for performing a coating/developing process on the wafer w, and include a FOUP platform 51 for mounting a plurality of FOUPs 2; a first transfer section 54 having a first transfer mechanism 53 for performing wafer transfer between the FOUP's 2 and a processing section 52; and an interface section 56 provided on an opposite side of the FOUP platform 51 across the processing section 52 and to be connected to an exposure section 55. The processing section 52 is provided with a second transfer section 59 having a second transfer mechanism 58 that is movable along a passageway 57. The second transfer mechanism 58 performs the transfer of the wafers w between the first transfer mechanism 53 and processing units 60 to 67 of the processing section 52. The first and the second transfer mechanism 53 and 58 respectively include transfer arms 53a and 58a for transferring the wafer.

On one side of the passageway 57, bake units 60, a brush cleaning unit 61, an adhesion processing unit 62, a chiller unit 63 therebelow, and a bake unit 64 are provided, and on the other side thereof, resist coating units 65, a cleaning unit 66, and developing units 67 are disposed. At the interface section 56, a transfer table 68 is provided to perform the transfer of the wafer with the exposure section 55.

At the ceiling portions of the first and the second transfer sections 54 and 59, FFU's 7 are provided (the FFU's of the first transfer section 54 are not shown). Each FFU 7 includes a fan 7a and a filter 7b as shown in FIG. 9A. Further, a chemical filter 69 is disposed above each FFU. Moreover, a wind velocity measuring unit 19 is provided at each of the transfer arms 53a and 58a of the first and the second transfer mechanisms 53 and 58 (see FIG. 9B). The wind velocity measuring units 19 are moved to predetermined measuring points in the transfer sections 54 and 59 by the transfer arms 53a and 58a of the transfer mechanisms 53 and 58 to collect measurement data, and operations of the FFU's 7 are controlled based on the measurement data. This processing apparatus 101 can also obtain the same effects as in the processing apparatus 1 shown in FIGS. 1 to 3.

FIG. 10 is a vertical cross sectional view schematically showing a configuration of still another modified embodiment of the processing apparatus in accordance with the preferred embodiment of the present invention. The processing apparatus (processing system) 102 shown in FIG. 10 is constituted as a vertical heat treatment system capable of batch processing multiple wafers at a time, and a front part in a housing 70 thereof serves as a transfer/storage area (transfer section) 71 of the FOUP's 2. A vertical heat treatment reactor 72 is provided in an upper portion of the rear part of the housing 70, and a loading area 73 is provided therebelow. A FOUP loading/unloading port 74 and a FOUP platform 75 are provided at a front portion of the transfer/storage area 71 and a rack-shaped storage section 76 for storing a plurality of FOUP's 2 is provided at an upper portion thereof.

Further, in the transfer/storage area 71, a FOUP platform 78 and a wafer loading/unloading port 79 are provided on a bulkhead between the transfer/storage area 71 and the loading area 73, and a first transfer mechanism 80 is provided between the FOUP platform 75 and 78 to transfer the FOUP's 2 among the two platforms 75 and 78 and the storage section 76. At the loading area 73, there is provided an elevation mechanism (not shown) for loading and unloading a boat 82 held on a lid 81 for opening and closing a reactor opening of the heat treatment reactor 72. The boat 82 can accommodate a plurality of, e.g., 100, wafers at multiple levels thereon. Also, there is provided a second transfer mechanism (transport mechanism) 83 for transferring the wafers between the FOUP 2 and the boat 82.

A FFU 7 for supplying the clean air to the storage section 76 is disposed at the rear side thereof, and a wind velocity measuring unit 19 is provided at a transfer arm 80a of the first transfer mechanism 80. The wind velocity measuring unit 19 is moved to a predetermined measuring point in the storage section 76 of the transfer/storage area (transfer section) 71 by the transfer arm 80a of the transfer mechanism 80 to collect measurement data and controlling the operations of the FFU 7 based thereon. Further, in the loading area 73, a FFU (not shown) may be disposed to supply the clean air from one side to the other side in a direction normal to the sheet of FIG. 10, and a wind velocity measuring unit (not shown) may be provided at the second transfer mechanism 83. And the wind velocity measuring unit may be moved to a predetermined measuring point in the loading area 73 by the second transfer mechanism 83 to collect measurement data and controlling the operations of the FFU 7 based thereon. The processing apparatus 102 can also obtain the same effects as in the processing apparatus 1 shown in FIGS. 1 to 3.

Although the preferred embodiment of the present invention has been shown and described with respect to the drawings, the present invention is not limited thereto. Various changes and modifications may be made without departing from the scope of the invention. For example, in the processing apparatus, a processing chamber for performing a CVD process, an atmospheric process, or the like may be employed. As the wind velocity measuring unit, a wine vane, for example, three-dimensional wind vane may be included.

While the invention has been shown and described with respect to the preferred embodiment, it will be understood by those skilled in the art that various changes and modifications may be made without departing from the scope of the invention as defined in the following claims.

What is claimed is:

1. A processing apparatus comprising:
a mounting unit for mounting a transport container for accommodating therein a plurality of substrates;
a processing unit for performing a process on a substrate;
a transfer unit having a transfer mechanism for transferring the substrate between the transport container mounted on the mounting unit and the processing unit; and
a clean air supply unit for supplying a clean air into the transfer unit,
wherein the transfer mechanism is provided with a wind velocity measuring unit for measuring a wind velocity of the clean air in the transfer unit.

2. A processing apparatus comprising:
a mounting unit for mounting a transport container for accommodating therein a plurality of substrates;
a processing unit for performing a process on a substrate;
a transfer unit having a transfer mechanism for transferring the substrate between the transport container mounted on the mounting unit and the processing unit;
a fan filter unit having a fan and a filter for supplying a clean air into the transfer unit;
a wind velocity measuring unit provided at the transfer mechanism for measuring a wind velocity of the clean air in the transfer unit; and
a control unit for moving the wind velocity measuring unit to a predetermined measuring point in the transfer unit by the transfer mechanism to collect measurement data and controlling operations of the fan filter unit based on the measurement data.

3. A fan filter unit monitoring and controlling system for monitoring and controlling fan filter units, disposed in a plurality of divided zones of a ceiling portion of a transfer unit for supplying a clean air into the transfer unit having a transfer mechanism for transferring a substrate, the system comprising:
a fan filter unit controller for controlling operations of the fan filter units;
a transfer mechanism controller for controlling the transfer mechanism;
a wind velocity measuring unit provided at the transfer mechanism to measure a wind velocity of the clean air in the transfer unit;
a user interface for inputting a measuring point at each zone of the transfer unit; and
a controller, connected to the user interface, the transfer mechanism controller and the wind velocity measuring unit by a network, for collecting measurement data of the respective measuring points from the transfer mechanism controller and the wind velocity measuring unit to thereby control and monitor operation states of the fan filter units.

4. A program for performing, on a computer, a monitoring and controlling of fan filter units, disposed in a plurality of divided zones of a ceiling portion of a transfer unit, for supplying a clean air into the transfer unit having a transfer mechanism for transferring a substrate, the program comprising:
a measurement data collection module for moving a wind velocity measuring unit provided at the transfer mechanism to a predetermined measuring point in the transfer unit by the transfer mechanism to collect measurement data; and
a fan filter unit monitoring and controlling module for monitoring operation states of the fan filter units and controlling operations of the fan filter units based on the measurement data.
